(19) United States
(12) Patent Application Publication
(10) Pub. No.: US 2012/0304465 A1
(43) Pub. Date: Dec. 6, 2012

(54) APPARATUS AND A METHOD OF SHAPING AN EDGE OF AN AEROFOIL

(75) Inventors: Sathyan SUBBIAH, Singapore (SG); Ajay Ratnakar MANDE, Derby (GB)

(73) Assignee: ROLLS-ROYCE PLC, London (GB)

(21) Appl. No.: 13/479,859

(22) Filed: May 24, 2012

(30) Foreign Application Priority Data
Jun. 3, 2011 (GB) 1109301.0

(51) Int. Cl. B23P 6/00; B21D 37/00

(52) U.S. Cl. 29/889.1; 72/465.1

(57) ABSTRACT

An apparatus for shaping an edge of an aerofoil comprising a brush and the brush comprises a plurality of bristles extending substantially parallel to each other. A motor rotates the brush about an axis. The axis is arranged substantially parallel to the bristles of the brush. A support structure holds the brush such that the axis intersects a first surface of the edge of the aerofoil or holds the brush such that the axis intersects a second surface of the edge of the aerofoil. There are means to move the brush such that the brush contacts the first surface of the edge or such that the brush contacts the second surface of the edge. There are means to produce relative movement of the brush and the aerofoil such that the first brush moves longitudinally along the edge of the aerofoil to shape the edge of the aerofoil.

The present invention relates to an apparatus and a method of shaping an edge of an aerofoil and in particular to an apparatus and method of shaping a leading edge of a gas turbine engine fan blade or compressor blade.

The leading edges of fan blades and/or compressor blades of gas turbine engines suffer from erosion during operation due to particles flowing into the intake of the gas turbine engine impacting and eroding the leading edges of the fan blades and/or the leading edges of the compressor blades. The leading edges of the fan blades and the compressor blades are generally provided with a profiled leading edge, e.g. an elliptical leading edge, for optimum aerodynamic efficiency. However, during operation of the gas turbine engine the impacts of particles on the leading edges of the fan blades and/or the leading edges of the compressor blades erodes and blunts the leading edges of the fan blades and/or the leading edges of the compressor blades. The blunting of the leading edges of the fan blades and/or the leading edges of the compressor blades reduces the efficiency and/or the flutter margin of the fan and/or compressor of the gas turbine engine.

There is a need for an apparatus and a method to shape, or re-shape, the leading edge of a fan blade or compressor blade of a gas turbine engine.

Accordingly the present invention provides an apparatus for shaping an edge of an aerofoil, the apparatus comprising a brush, the brush comprising a plurality of bristles extending substantially parallel to each other, a device arranged to rotate the brush about an axis, the axis being arranged substantially parallel to the bristles of the brush, a support structure arranged to hold the brush such that the axis intersects a first surface of an edge of an aerofoil, means to move the brush such that the brush contacts the first surface of the edge, means to produce relative movement between the brush and the aerofoil such that the brush moves longitudinally along the first surface of the edge of the aerofoil to shape the edge of the aerofoil.

The support structure may be arranged to hold the brush such that the axis intersects the first surface at angle in the range of 30° to 75°.

The support structure may be arranged to hold the brush such that the axis intersects the first surface at angle in the range of 55° to 75°.

The support structure may comprise an adjuster to vary the angle at which the axis of the brush intersects the first surface.

The brush may comprise alumina, or silicon carbide, bristles.

The device may comprise a motor. The motor may comprise an electric motor, a hydraulic motor or a pneumatic motor. The device may comprise gears. The motor may be arranged to drive the brush via the gears.

The present invention also provides a method of shaping an edge of an aerofoil, the method comprising a) providing a brush, the brush comprising a plurality of bristles extending substantially parallel to each other, b) rotating the brush about an axis, the axis being arranged substantially parallel to bristles of the brush, c) arranging the axis to intersect a first surface of an edge of an aerofoil, d) moving the brush such that the brush contacts the first surface of the edge, e) producing relative movement between the brush and the aerofoil such that the brush moves longitudinally along the first surface of the edge of the aerofoil to shape the edge of the aerofoil.

The method may comprise f) arranging the axis to intersect a second surface of the edge of the aerofoil, g) moving the brush such that the brush contacts the second surface of the edge, h) producing relative movement between the brush and the aerofoil such that the brush moves longitudinally along the second surface of the edge of the aerofoil to shape the edge of the aerofoil.

The method may comprise arranging the axis to intersect the first surface at angle in the range of 30° to 75°.

The method may comprise arranging the axis to intersect the first surface at angle in the range of 55° to 75°.

The method may comprise varying the angle at which the axis intersects the first surface.

The brush may comprise alumina, or silicon carbide, bristles.

The method may comprise shaping the edge of a gas turbine engine aerofoil. The method may comprise shaping the edge of a fan blade or a compressor blade. The method may comprise shaping a leading edge of an aerofoil.

The method may comprise reshaping an edge of a worn aerofoil. The method may comprise shaping the edge of the aerofoil while the aerofoil is in the gas turbine engine. The aerofoil may be an aerofoil of integrally bladed disc or a separate aerofoil mounted in a slot in the periphery of a disc or in a slot in the periphery of a drum.

Alternatively the method may comprise shaping the edge of a steam turbine aerofoil, a water turbine aerofoil, a wind turbine aerofoil etc.

The present invention also provides a method of shaping the edge of a component, the method comprising a) providing a brush, the brush comprising a plurality of bristles extending substantially parallel to each other, b) rotating the brush about an axis, the axis being arranged substantially parallel to bristles of the brush, c) arranging the axis to intersect a first surface of an edge of a component, d) moving the brush such that the brush contacts the first surface of the edge, e) producing relative movement between the brush and the component such that the brush moves longitudinally along the first surface of the edge of the component to shape the edge of the component.

The present invention provides an apparatus for shaping an edge of a component, the apparatus comprising a brush, the brush comprising a plurality of bristles extending substantially parallel to each other, a device arranged to rotate the brush about an axis, the axis being arranged substantially parallel to the bristles of the brush, a support structure arranged to hold the brush such that the axis intersects a first surface of an edge of a component, means to move the brush such that the brush contacts the first surface of the edge, means to produce relative movement between the brush and the component such that the brush moves longitudinally along the first surface of the edge of the component to shape the edge of the component.

The present invention will be more fully described by way of example with reference to the accompanying drawings, in which:

FIG. 1 is a cross-sectional view of an upper half of a turbofan gas turbine engine showing a fan blade which has a leading edge which has been shaped using a method according to the present invention.

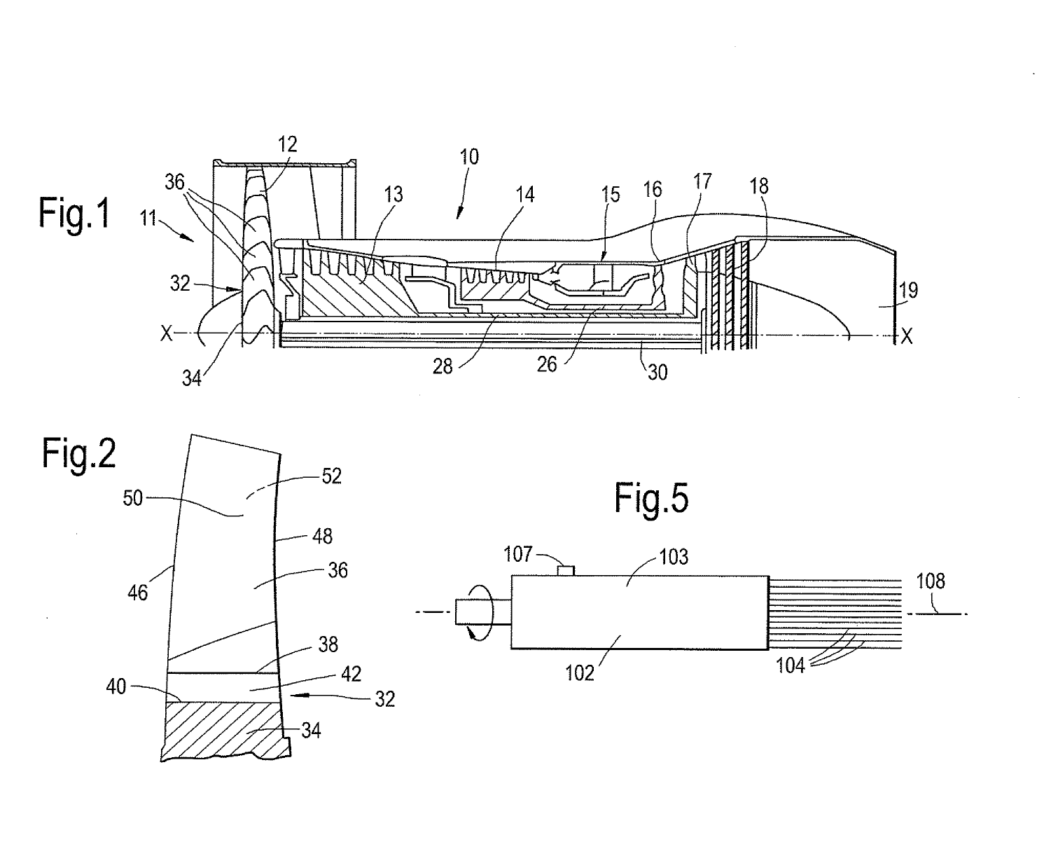

FIG. 2 is an enlarged cross-sectional view through a portion of a fan rotor assembly showing a fan blade which has a leading edge which has been shaped using a method according to the present invention.

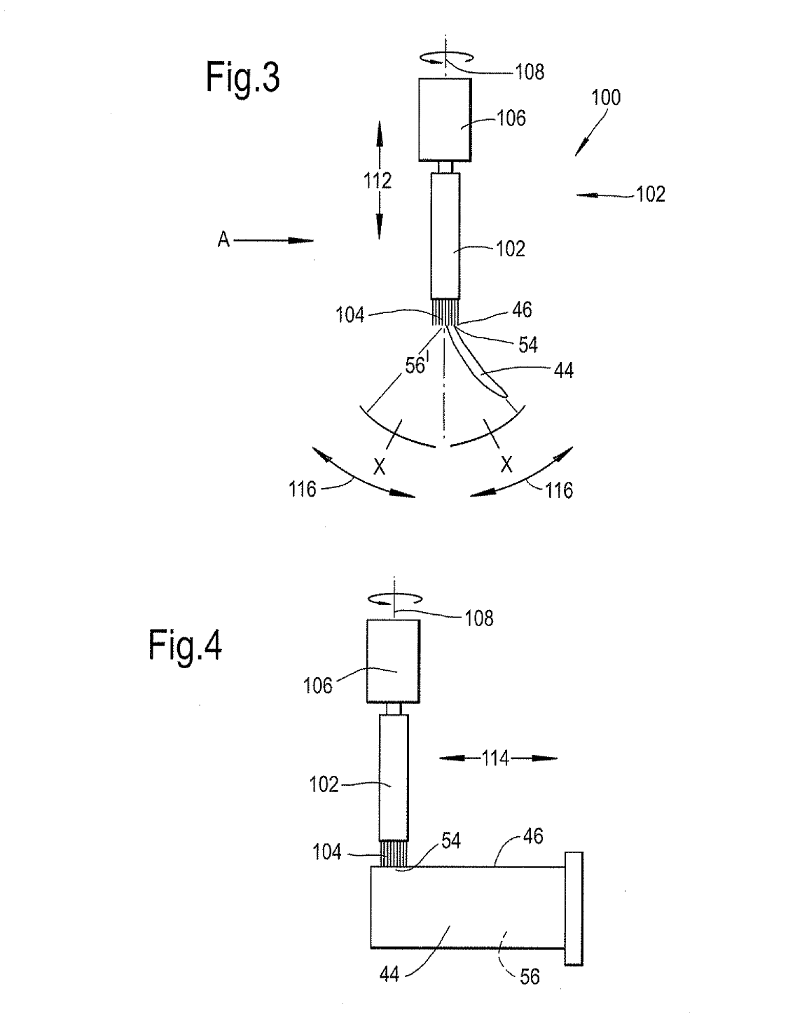

FIG. 3 is a view of an apparatus for shaping an edge of an aerofoil according to the present invention.

FIG. 4 is a view in the direction of arrow A in FIG. 3 showing the apparatus for shaping an edge of an aerofoil.

FIG. 5 is an enlarged view of a brush.

A turbofan gas turbine engine 10, as shown in FIG. 1, comprises in flow series an intake 11, a fan 12, an intermediate pressure compressor 13, a high pressure compressor 14, a combustor 15, a high pressure turbine 16, an intermediate pressure turbine 17, a low pressure turbine 18 and an exhaust 19. The high pressure turbine 16 is arranged to drive the high pressure compressor 14 via a first shaft 26. The intermediate pressure turbine 17 is arranged to drive the intermediate pressure compressor 14 via a second shaft 28 and the low pressure turbine 19 is arranged to drive the fan 12 via a third shaft 30. In operation air flows into the intake 11 and is compressed by the fan 12. A first portion of the air flows through, and is compressed by, the intermediate pressure compressor 13 and the high pressure compressor 14 and is supplied to the combustor 15. Fuel is injected into the combustor 15 and is burnt in the air to produce hot exhaust gases which flow through, and drive, the high pressure turbine 16, the intermediate pressure turbine 17 and the low pressure turbine 18. The hot exhaust gases leaving the low pressure turbine 18 flow through the exhaust 19 to provide propulsive thrust. A second portion of the air bypasses the main engine to provide propulsive thrust.

The fan 12, as shown in FIG. 2, comprises a fan rotor assembly 32 comprising a fan rotor, a fan disc, 34 and a plurality of circumferentially spaced radially outwardly extending fan rotor blades 36. The fan rotor, fan disc, 34 has a rim 38 and a plurality of circumferentially spaced slots 40 are provided in the rim 38 of the fan rotor, fan disc 34. Each fan rotor blade 36 has a root 42 and the root 42 of each fan rotor blade 36 is arranged in a corresponding one of the slots 40 in the rim 38 of the fan rotor, fan disc 34. The root 42 of each fan rotor blade 36 is firtree shaped, or dovetail shaped, in cross-section and each slot 40 is correspondingly shaped to receive the root 42 of the corresponding fan rotor blade 36. Alternatively the fan rotor blades 36 are integral with the fan rotor, fan disc, 34 and the fan rotor blades 36 are friction welded, laser welded, electron beam welded or diffusion bonded to the periphery of the fan rotor, fan disc, 34.

Each fan rotor blade 36 also has an aerofoil 44 and the aerofoil 44 of each fan rotor blade 36 has a leading edge 46, a trailing edge 48, a convex suction surface 50 extending from the leading edge 46 to the trailing edge 48 and a concave pressure surface 52 extending from the leading edge 46 to the tailing edge 48. The leading edge 46 of the aerofoil 44 of each fan rotor blade 36 is generally elliptical in profile, but other suitable shapes may be used.

As mentioned previously the leading edges 46 of the aerofoils 44 of the fan rotor blades 36 suffer from erosion during operation of the turbofan gas turbine engine 10 and the aerodynamic efficiency and surge margin of the fan 12 is reduced. Thus, it is desirable to restore the leading edges 46 of the aerofoils 44 of the fan rotor blades 36 back to their original shape.

An apparatus 100 for shaping an edge 46 of an aerofoil 44, as shown in FIGS. 3 and 4, comprises a brush 102. The brush 102 comprises a plurality of bristles 104. The bristles 104 extend substantially parallel to each other, as shown in FIG. 5. A motor 106 is arranged to rotate brush 102 about an axis 108 and the axis 108 is arranged substantially parallel to the bristles 104 of the brush 102. The apparatus 100 comprises a CNC, computer numerically controlled, machining centre, e.g. a 4 axis vertical machining centre, in which the axis 108 of rotation of the brush 102 is a vertical axis of rotation. A support structure 110 is arranged to hold the brush 102 such that the axis 108 intersects an edge 46 of an aerofoil 44. There are means 112 to position, or move, the brush 102 such that the brush 102 moves vertically downwards to contact a first surface 54 of the edge 46 of the aerofoil 44 or the means 112 is arranged to position, or move, the brush 102 such that the brush 102 moves vertically downwards to contact a second surface 56 of the edge 46 of the aerofoil 44. There are means 114 to produce relative movement between the brush 102 and the aerofoil 44 such that the brush 102 moves longitudinally along the first surface 54 of the edge 46 of the aerofoil 44 to shape the edge 46 of the aerofoil 44 or the means 114 is arranged to produce relative movement between the brush 102 and the aerofoil 44 such that the brush 102 moves longitudinally along the second surface 56 of the edge 46 of the aerofoil 44 to shape the edge 46 of the aerofoil 44. The first and second surfaces 54 and 56 meet at the leading edge 46 of the aerofoil 44.

The support structure 110 is arranged to hold the brush 102 such that the axis 108 intersects the first surface 54 and/or the second surface 56 at angle X in the range of 30° to 60°. The support structure 110 is arranged to hold the brush 102 such that the axis 108 intersects the first and second surfaces 54 and 56 respectively at an angle of 45°. The support structure 110 comprises has means 116 to vary the angle at which the axis 108 of the brush 102 intersects the first and second surfaces 54 and 56 respectively. In particular the means 116 to vary the angle rotates the aerofoil 44 about a horizontal axis. The support structure 110 is arranged to hold the brush 102 such that the axis 108 intersects the first surface 54 and/or the second surface 56 at angle X in the range of 30° to 75°, preferably in the range of 55° to 75°, more preferably 60°.

The brush 102 comprises alumina bristles 106 but other suitable abrasive bristles may be used. The brush 102 may comprise a XEBEC (RTM) brush obtained from Xebec Technology Co, Japan, and especially a XEBEC (RTM) A21 white brush, which comprises a sleeve 103 in which the bristles 104 are held and the free length of the bristles 104 extending from the sleeve 103 is adjustable using a screw 107 as shown in FIG. 5.

The motor 106 may comprise an electric motor, a hydraulic motor or a pneumatic motor.

As seen in FIGS. 3 and 4, the aerofoil 44 is held such that it extends substantially horizontally from the 4 axis vertical machining centre and the edge 46 of the aerofoil 44 extends substantially horizontally. In operation, initially the axis 108 is arranged to intersect the first surface 54 of the edge 46 of the aerofoil 44. Then the brush 102 is positioned, or moved, such that the brush 102 contacts the first surface 54 of the edge 46 of the aerofoil 44. Then the brush 102 is rotated about the axis 108 and relative movement is provided between the brush 102 and the aerofoil 44 such that the brush 102 moves longitudinally along the edge 46 of the aerofoil 14 to shape the edge 46 of the aerofoil 44 and in particular shapes the first surface 54 of the edge 46 of the aerofoil 44. Then the axis 108 is arranged to intersect the second surface 56 of the edge 46 of the aerofoil 44. Then the brush 102 is positioned, or moved, such that the brush 102 contacts the second surface 56 of the edge 46 of the aerofoil 44. Next the brush 102 is rotated about the axis 108 and relative movement is provided between the brush 102 and the aerofoil 44 such that the brush 102 moves longitudinally along the edge 46 of the aerofoil 14 to shape the edge 46 of the aerofoil 44 and in particular shapes the second surface 54 of the edge 46 of the aerofoil 44.

Either the brush 102 and support structure 110 are held stationary and the aerofoil 44 is moved or the brush 102 and support structure 110 are moved and the aerofoil 44 is held stationary to move the brush 102 longitudinally along the edge 46 of the aerofoil 44. The aerofoil 44 is rotated around a horizontal axis such that the edge 46 of the aerofoil 44 makes the appropriate angle with the axis 108 of rotation of the brush 102. The aerofoil 44 is rotated about the horizontal axis such that either the first surface 54 or the second surface 56 of the edge 46 of the aerofoil 44 makes the appropriate angle with the axis 108 of rotation of the brush 102.

The rotational speed of the brush 102 may be varied, the brush 102 may be moved towards or away from the edge 46 of the aerofoil 44 to take into account the thickness of the aerofoil 44 and the angle of the axis of rotation 108 of the brush 102 may be varied to allow different profiles, different ellipses, to be produced at the edge 46 of the aerofoil 44. The angle of the brush with respect to the aerofoil, the free length of the bristles, the overall depth of cut of the brush against the aerofoil, the number of cuts of the brush along the edge of the aerofoil at different positions relative to the aerofoil, the number of passes of the brush along the edge of the aerofoil at the same position relative to the aerofoil, the rotational speed of the brush and the feed rate, the speed, at which the brush moves along the edge of the aerofoil may all be varied to vary the ellipse ratio for the edge of the aerofoil.

In one example the brush was set at an angle of 45°, the feed rate was 200 mm/min, the brush rotation speed was 5000 rpm, number of passes per side was 2, the depth of cut was 0.75 mm and the brush was a XEBEC A21 brush. The brush speed of rotation may be between 3000 rpm and 5000 rpm inclusive, the feed rate may be between 200 mm and 500 mm inclusive, the depth of cut may be between 0.6 mm and 1.2 mm inclusive, the diameter of the brush may be between 6 mm and 15 mm inclusive, the angle may be between 30° to 75° inclusive, preferably in the range of 55° to 75° inclusive, more preferably 60° or the angle may be between 30° to 60° inclusive.

The method may comprise shaping the edge of a gas turbine engine aerofoil. The method may comprise shaping the edge of a fan blade, a fan outlet guide vane, a compressor blade or a compressor vane. The method may comprise shaping a leading edge of an aerofoil, e.g. a blade or a vane. The aerofoil may comprise a titanium alloy, a nickel or steel. An example of a titanium alloy is titanium 6-4 consisting of 6 wt % aluminium, 4 wt % vanadium and the balance titanium plus incidental impurities and minor additions. An example of a nickel alloy is Inconel 718.

In an alternative method the brush may be moved around the leading edge of the aerofoil from the first surface to the second surface and an appropriate angle is made between the axis of rotation of the brush and the leading edge at each position around the leading edge as the brush is moved from the first surface to the second surface while the brush is at a particular longitudinal position at the leading edge of the aerofoil. This procedure is then repeated at all positions on the leading edge of the aerofoil.

The method may comprise reshaping an edge of a worn aerofoil. The method may comprise shaping the edge of the aerofoil while the aerofoil is in the gas turbine engine. The aerofoil may be an aerofoil of integrally bladed disc or a separate aerofoil mounted in a slot in the periphery of a disc or separate aerofoil mounted in a slot in the periphery of a drum. The method may comprise removing a casing from gas turbine engine and then shaping the aerofoil while the aerofoil is on an integrally bladed disc or while the aerofoil is mounted in a slot in the periphery of a disc or while the aerofoil is mounted in a slot in the periphery of a drum of the gas turbine engine. The method may comprise mounting the apparatus on an aerofoil and then moving the brush along the edge of the aerofoil.

Alternatively the CNC, computer numerically controlled, machining centre may comprise a 4 axis horizontal machining centre in which the axis of rotation of the brush is arranged horizontally. The aerofoil extends vertically and the edge of the aerofoil is arranged to extend substantially vertically and then the aerofoil is rotated about a vertical axis such that the edge of the aerofoil makes the appropriate angle with the axis of rotation of the brush. The aerofoil is rotated about the horizontal axis such that either the first surface, or the second surface, of the edge of the aerofoil makes the appropriate angle with the axis of rotation of the brush.

The present invention is equally applicable to aerofoils for other gas turbine engines, e.g. turbojet, turboprop and turboshaft gas turbine engines and for gas turbine engine with one, two or more shafts. The present invention is equally applicable for shaping edges, e.g. leading edges, of blades or vanes.

1. An apparatus for shaping an edge of an aerofoil, the apparatus comprising a brush, the brush comprising a plurality of bristles extending substantially parallel to each other, a device arranged to rotate the brush about an axis, the axis being arranged substantially parallel to the bristles of the brush, a support structure arranged to hold the brush such that the axis intersects a first surface of an edge of an aerofoil, means to move the brush such that the brush contacts the first surface of the edge, means to produce relative movement between the brush and the aerofoil such that the brush moves longitudinally along the first surface of the edge of the aerofoil to shape the edge of the aerofoil.

2. An apparatus as claimed in claim 1 wherein the support structure is arranged to hold the brush such that the axis intersects the first surface at angle in the range of 30° to 75°.

3. An apparatus as claimed in claim 2 wherein the support structure is arranged to hold the brush such that the axis intersects the first surface at angle in the range of 30° to 75°.

4. An apparatus as claimed in claim 1 wherein the support structure comprises an adjuster to vary the angle at which the axis of the brush intersects the first surface.

5. An apparatus as claimed in claim 1 wherein the bristles are selected from the group comprising alumina bristles and silicon carbide bristles.

6. An apparatus as claimed in claim 1 wherein the device is selected from the group comprising an electric motor, a hydraulic motor and a pneumatic motor.

7. A method of shaping an edge of an aerofoil, the method comprising a) providing a brush, the brush comprising a plurality of bristles extending substantially parallel to each other, b) rotating the brush about an axis, the axis being arranged substantially parallel to bristles of the brush, c) arranging the axis to intersect a first surface of an edge of an aerofoil, d) moving the brush such that the brush contacts the first surface of the edge, e) producing relative movement between the brush and the aerofoil such that the brush moves longitudinally along the first surface of the edge of the aerofoil to shape the edge of the aerofoil.

8. A method as claimed in claim 7 comprising f) arranging the axis to intersect a second surface of the edge of the aerofoil, g) moving the brush such that the brush contacts the second surface of the edge, h) producing relative movement between the brush and the aerofoil such that the brush moves longitudinally along the second surface of the edge of the aerofoil to shape the edge of the aerofoil.

9. A method as claimed in claim 7 comprising arranging the axis to intersect the surface at angle in the range of 30° to 75°.

10. A method as claimed in claim 9 comprising arranging the axis to intersect the surface at angle in the range of 55° to 75°.

11. A method as claimed in claim 7 comprising varying the angle at which the axis intersect the surface.

12. A method as claimed in claim 7 wherein the bristles are selected from the group comprising alumina bristles and silicon carbide bristles.

13. A method as claimed in claim 7 comprising shaping the edge of a gas turbine engine aerofoil.

14. A method as claimed in claim 13 wherein the gas turbine engine aerofoil is selected from the group comprising a fan blade and a compressor blade.

15. A method as claimed in claim 7 comprising shaping a leading edge of an aerofoil.

16. A method as claimed in claim 7 comprising reshaping an edge of a worn aerofoil.

17. A method as claimed in claim 13 comprising shaping the edge of the aerofoil while the aerofoil is in the gas turbine engine.

18. A method as claimed in claim 7 wherein the aerofoil is selected from the group comprising an aerofoil of integrally bladed disc, a separate aerofoil mounted in a slot in the periphery of a disc and a separate aerofoil mounted in a slot in the periphery of a drum.
